(19) United States
(12) Patent Application Publication
(10) Pub. No.: US 2025/0214619 A1
(43) Pub. Date: Jul. 3, 2025

(54) MANAGEMENT OF TRUST METRICS FOR AUTONOMOUS VEHICLE OPERATION

(71) Applicant: Intel Corporation, Santa Clara, CA (US)

(72) Inventors: Vyasa Sai, Folsom, CA (US); Cagri Cagatay Tanriover, Bethany, OR (US)

(21) Appl. No.: 18/397,531

(22) Filed: Dec. 27, 2023

(51) Int. Cl. B60W 60/00; B60W 30/09; B60W 40/08; B60W 50/14; G06V 20/58

(52) U.S. Cl. CPC B60W 60/0015; B60W 30/09; B60W 40/08; B60W 50/14; G06V 20/58; B60W 2555/20

(57) ABSTRACT

A system of a vehicle having access to a network, includes a communication controller to interface with at least one of: a mobile device, the vehicle, and sensors coupled to the vehicle; and a vehicle controller to perform a responsive operation at the vehicle; where the system is to: identify a target vehicle operating in proximity of the vehicle; determine a trust metric, the trust metric indicating a measurement of risk to operate the vehicle in the proximity of the target vehicle; and initiate the responsive operation at the vehicle, using the vehicle controller, based on the trust metric.

### BACKGROUND

Autonomous or semi-autonomous automotive technologies, often referred to as “self-driving” or “assisted-driving” operation in automobiles, are undergoing rapid development and deployment in commercial- and consumer-grade vehicles. A variety of sensor technologies may be used to monitor the vehicle's surroundings, such as the road surface and boundaries, other vehicles, pedestrians, objects and hazards, signage and road markings, and other relevant items.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to control an autonomous vehicle, according to an embodiment;

FIG. 2 is a data flow diagram illustrating a process and system to use trust metrics for a vehicle, according to an embodiment;

FIG. 3 is a diagram illustrating an operational environment, according to an example;

FIG. 4 is a flowchart illustrating a method for calculating a vehicle reputation, according to an example;

FIG. 5 is a flowchart illustrating a method for calculating a maintenance risk, according to an example;

FIG. 6 is a flowchart illustrating a method for calculating a survival likelihood, according to an example;

FIG. 7 is a diagram illustrating an operational environment, according to an example;

FIG. 8 is a flowchart illustrating a method for calculating a license risk, according to an example;

FIG. 9 is a flowchart illustrating a method for calculating an accident risk, according to an example;

FIG. 10 is a flowchart illustrating a method for calculating an offense risk, according to an example;

FIG. 11 is a diagram illustrating an operational environment, according to an example;

FIG. 12 is a flowchart illustrating a method for calculating a weather risk, according to an example;

FIG. 13 is a flowchart illustrating a method for calculating a road risk, according to an example;

FIG. 14 is a flowchart illustrating a method for generating a trust metric, according to an embodiment; and

FIG. 15 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Autonomous vehicles (AVs) are vehicles that are capable of operating without human assistance. AVs may operate in a fully autonomous mode or a partially autonomous mode. When in a partially autonomous mode, the AV may provide some autonomous functionality, such as lane departure monitoring, speed control, collision avoidance, or the like while the human operator performs other aspects of driving, such as steering.

Advancements in AV operation continue to be developed and released. In the future, fully autonomous vehicles may be operating on open roads. Such AVs may interact with conventional human-operated vehicles. Developers are designing AV functions to operate in a manner that is at least as safe as human-operated ones.

While it is accepted that in a not-so-distant future, all vehicles on the road will be fully autonomous, a few decades of co-existence of autonomous and traditional vehicles on the road is expected. Unlike autonomous vehicles, human drivers are likely to cut corners and break the law by making choices that are convenient for them. For example, a human driver may delay a critical vehicle maintenance due to cost concerns or even simply due to laziness. Human drivers also take risks such as driving with a suspended or revoked license regardless of the serious outcomes of doing so. All these behavioral patterns and preferences, introduce risk for all road users and currently there is no method to capture and communicate how much a human driver and his/her vehicle can be trusted by other road users. With the lack of such trust information, road users can only blindly guess whether they can expect a human driver to drive safely in a roadworthy vehicle.

What is needed is a framework to gather, sense, store, and distribute information about vehicles, drivers, road conditions, and other information of a vehicle's operating context to provide additional insights to an AV for operation. The systems and mechanisms described here support practical applications of autonomous vehicle operation, increased intelligent decision-making, and increased occupant safety. Additional details are provided below.

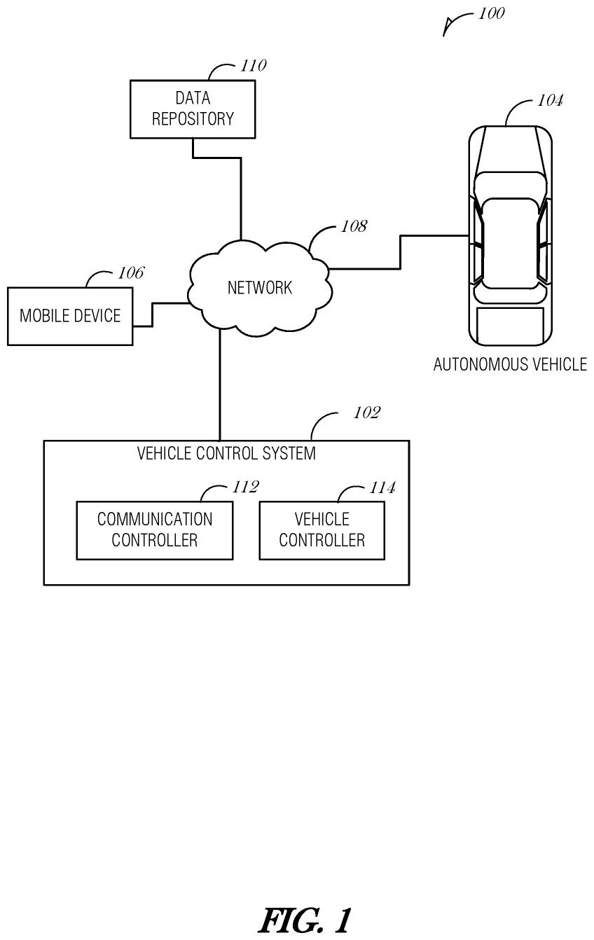

FIG. 1 is a schematic drawing illustrating a system 100 to control an autonomous vehicle, according to an embodiment. FIG. 1 includes a vehicle control system 102 and an autonomous vehicle 104 communicatively coupled via a network 108. A mobile device 106 may be used to interface with the autonomous vehicle 104 or the vehicle control system 102.

The vehicle 104 may be any type of vehicle, such as a commercial vehicle, a consumer vehicle, a recreation vehicle, a car, a truck, a motorcycle, a boat, a drone, a robot, an airplane, a hovercraft, or any mobile craft able to operate at least partially in an autonomous mode. The vehicle 104 may operate at some times in a manual mode where the driver operates the vehicle 104 conventionally using pedals, steering wheel, and other controls. At other times, the vehicle 104 may operate in a fully autonomous mode, where the vehicle 104 operates without user intervention. In addition, the vehicle 104 may operate in a semi-autonomous mode, where the vehicle 104 controls many of the aspects of driving, but the driver may intervene or influence the operation using conventional inputs (e.g., steering wheel) or non-conventional inputs (e.g., voice control).

The vehicle 104 includes a sensor array, which may include various forward, side, and rearward facing cameras, radar, LIDAR, ultrasonic, very high-frequency (VHF) radar, or the like. Forward-facing is used in this document to refer to the primary direction of travel, the direction the seats are arranged to face, the direction of travel when the transmission is set to drive, or the like. Conventionally then, rear-facing or rearward-facing is used to describe sensors that are directed in a roughly opposite direction than those that are forward or front-facing. It is understood that some forward-facing cameras may have a relatively wide field of view, even up to 180-degrees. Similarly, a rear-facing camera that is directed at an angle (perhaps 60-degrees off center) to be used to detect traffic in adjacent traffic lanes, may also have a relatively wide field of view, which may overlap the field of view of a forward-facing camera. Side-facing sensors are those that are directed outward from the sides of the vehicle 104. Cameras in the sensor array may include infrared or visible light cameras, able to focus at long-range or short-range with narrow or large fields of view.

The autonomous vehicle 104 includes an on-board diagnostics system to record vehicle operation and other aspects of the vehicle's performance, maintenance, or status. The autonomous vehicle 104 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

The mobile device 106 may be a device such as a smartphone, cellular telephone, mobile phone, laptop computer, tablet computer, or other portable networked device. In general, the mobile device 106 is small and light enough to be considered portable and includes a mechanism to connect to the network 108, either over a persistent or intermittent connection.

The network 108 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 108 may include a single local area network (LAN) or wide-area network (WAN), or combinations of LANs or WANs, such as the Internet. The network 108 may also encompass in-vehicle networks, such as an on-board diagnostic network (e.g., OBD II), CANbus, Bluetooth, Ethernet, or other in-vehicle, short-range, small-area, or personal networks. The various devices (e.g., mobile device 106 or autonomous vehicle 104) coupled to the network 108 may be coupled to the network 108 via one or more wired or wireless connections. The mobile device 106 may act as a communication bridge between a local area network inside the autonomous vehicle 104 and a wide area network (e.g., the internet) outside of the vehicle.

In operation, the autonomous vehicle 104 obtains sensor data via the sensor array interface 102 from sensors integrated in the autonomous vehicle 104, or sensors that are communicatively coupled to the autonomous vehicle 104. The sensors may include radar, LiDAR, visible light cameras, acoustic sensors, environmental sensors, infrared sensors, or combinations. Radar is useful in nearly all weather and longer range detection, LiDAR is useful for shorter range detection, and cameras are useful for longer ranges but often become less effective in certain weather conditions, such as snow. Combinations of sensors may be used to provide the widest flexibility in varying operating conditions.

The vehicle control system 102 may include a communication controller 112 to interface with the mobile device 106 or the autonomous vehicle 104 and pass control and data to monitor environmental events, vehicle activity, vehicle status, geographical location, and the like. The vehicle control system 102 may use the communication controller 112 to communicate with sensors on the autonomous vehicle 104 to gather information about the road surface, weather conditions or events, time of day, location, route, other vehicles in the area, or the like. Using this data, the vehicle control system 102 is able to perform autonomous operations such as general lane guidance, navigation, obstacle avoidance, cooperative platooning, and the like.

The communication controller 112 may operate over the network 108 and may access the data repository 110 to acquire data about vehicles or drivers of vehicles around the autonomous vehicle 104, road conditions along the route of the autonomous vehicle 104, weather information, and other contextual operating conditions. The communication controller 112 may also upload data about experiences at the autonomous vehicle 104 (e.g., traffic information, vehicle status information about the autonomous vehicle 104, maintenance activity on the autonomous vehicle 104, and the like may be uploaded to the data repository 110 to update a shared database).

The vehicle control system 102 may also include a vehicle controller 114. The vehicle controller 114 may interface with one or more vehicle control subsystems, such as braking, acceleration, steering, suspension, lights (e.g., headlights or turn signals), climate controllers, visual/audio systems, etc. to operate the autonomous vehicle 104 in partial or full autonomous mode.

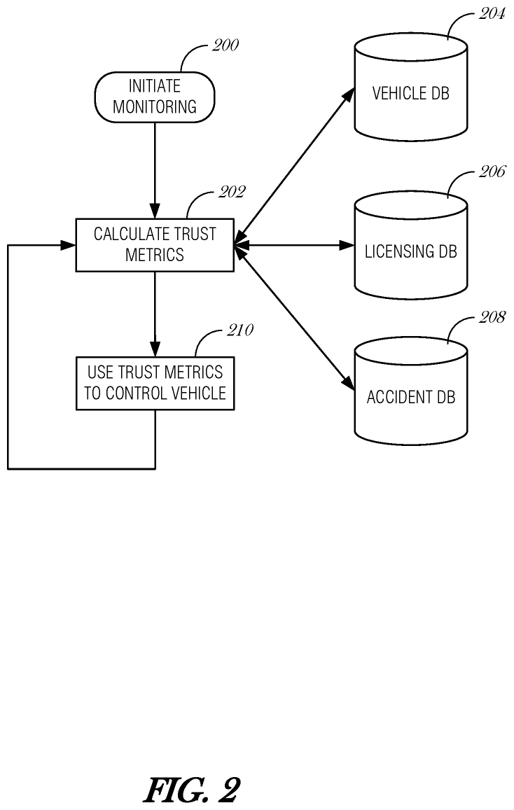

FIG. 2 is a data flow diagram illustrating a process and system to use trust metrics for a vehicle, according to an embodiment. At operation 200, the data and control flow initiates and the ego vehicle begins monitoring its environment. Monitoring may be implemented, at least in part, using communication circuitry or sensors installed on or in the ego vehicle. The ego vehicle may monitor its current geolocation using a location-based system (e.g., GPS), planned route, current direction of travel, and the like to identify portions of the travel path that are likely to be traversed. The ego vehicle may also monitor its status while in operation. Data collected during operation may include data related to the ego vehicle's performance, such as acceleration, deceleration, gyrometer, seat sensor data, steering data, and the like. The data may also include data about maintenance performed on the ego vehicle or maintenance needing to be performed (e.g., error codes, system status checks, check engine light, etc.). Operational data may also be related to the ego vehicle's occupants, operating environment (e.g., weather, lane configuration, traffic conditions), use, nearby vehicles (vehicles travelling in the same lanes, at an intersection, in opposite lanes, etc.), or the like.

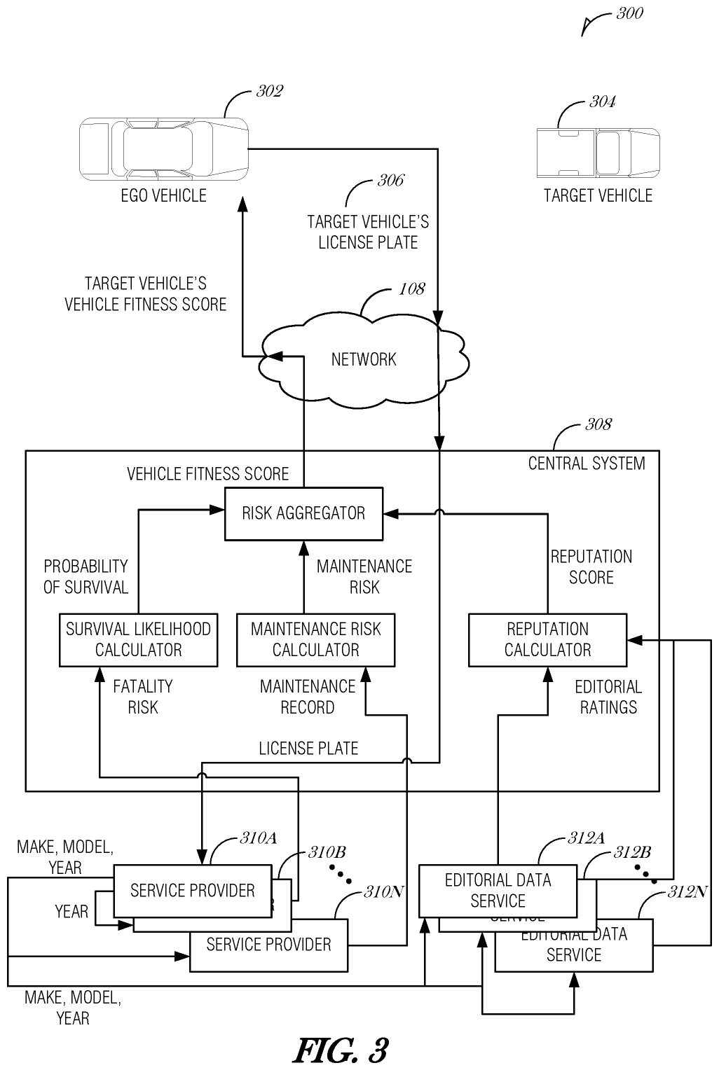

At operation 202, one or more trust metrics are calculated. Trust metrics that may be calculated include, but are not limited to a vehicle fitness score (VFS), a driver fitness score (DFS), and a situational safety score (SSS). These scores are described in more detail in FIGS. 3-13 below.

Trust metrics are calculated using data obtained from other vehicles being operated around the ego vehicle. The other vehicles may include similar monitoring capabilities as described here. Information is transmitted or obtained by the ego vehicle to access data for each of the trust metrics.

For instance, the ego vehicle may be equipped with a license plate reading mechanism to obtain license plate numbers of vehicles operating around the ego vehicle and identify them. As another example, the ego vehicle may communicate with vehicles operating in a certain proximity (e.g., 0.5 miles around the ego vehicle) and obtain vehicle information from each of the operating vehicles. The vehicle information includes vehicle identification, such as a vehicle identification number (VIN) or a license plate number.

A vehicle database 204 may be accessed to obtain information about the identified vehicle, its owner, its presumed driver/operator, and the like. The vehicle database 204 may be a governmental database, such as a database maintained by a Department of Motor Vehicles for a state or city, or a database maintained by the National Highway Traffic Safety Administration (NHTSA). Alternatively, the vehicle database 204 may be a private database, such as a warrantee database owned and operated by a vehicle warrantee provider that tracks claims and repairs performed under warrantee on vehicles, or a vehicle dealership or manufacturer that maintains records of vehicle repairs. As such, it is understood that the vehicle database 204 may be of various types of databases or may represent multiple databases.

A licensing database 206 may be accessed to obtain information about a registered owner of identified vehicles operating around the ego vehicle. The licensing database 206 may include information about the status of a license (e.g., revoked, suspended, active, etc.), whether there are any points on the license due to one or more traffic violations or offenses, the owner's age, gender, residence, and the like.

An accident database 208 may be accessed to obtain information about any accidents involving the identified vehicle. The accident database 208 may be operated by an insurance company, a warrantee provider, a repair shop, a police force, a data aggregator like CARFAX, Inc., etc. Data may be obtained from a regional motor vehicle agency, auto auctions, fire and police departments, collision repair facilities, fleet management and rental agencies, and more.

Some or all of the information contained in one database 204, 206, 208 may also exist in some form in another database 204, 206, 208. It is understood that the databases 204, 206, 208 do not store mutually exclusive information. Further, any of the database 204, 206, or 208 may be implemented with multiple databases, which may be from multiple sources or maintained by multiple different services.

At operation 210, one or more of the trust metrics are used to control an aspect of the ego vehicle. In an example, one or more of the trust metrics are used to warn the driver/operator of the ego vehicle of other vehicles or drivers/operators on the road. In another example, one or more of the trust metrics are used as an input into a decision-making process, which may be part of an autonomous navigation operation. For instance, if the ego vehicle is operating in full autonomous mode and the trust metric of vehicle fitness of a nearby vehicle is below some value, then the ego vehicle may navigate to change lanes away from the vehicle with the low trust metric. It is understood that the types of operations that the ego vehicle may perform based on the trust metrics values is fluid and open-ended. Just about any type of decision made by an autonomous vehicle may be influenced by the trust metrics of the vehicles operating around it.

As discussed above, three trust metrics are described herein: a vehicle fitness score, a driver fitness score, and a situational score. These three scores are based on historical data and trends associated with the human driver and their vehicle. The trust metrics provide a likelihood (e.g., a value between 0% and 100%) that a human driver or a vehicle poses a risk on the road. The framework to generate trust metrics itself does not provide thresholds, rules, guidance, or other policies. Instead, the trust metrics can be used in flexible ways. For instance, system designers can use one or more of the trust metrics independently, or as an aggregated trust metric, which is a combination of two or more of the scores, to trigger actions based on regulations or design specifications in their target autonomous vehicle platform.

FIG. 3 is a diagram illustrating an operational environment 300, according to an example. The operational environment 300 is used to determine a first example trust metric—the vehicle fitness score (VFS). At a high level, the VFS is calculated using three components: 1) vehicle reputation; 2) maintenance risk; and 3) survival likelihood. More or fewer components may be used to calculate the VFS. The components are combined, e.g., in a weighted formula, to derive the VFS for a particular vehicle.

An ego vehicle 302 is equipped with an image capture system. The image capture system may include one or more cameras of one or more types. Cameras may be infrared or visible light cameras, able to focus at long-range or short-range with narrow or large fields of view, and may be installed or affixed to the ego vehicle 302 to provide imaging in a front arc, a rear arc, a full 360 degree circle around the ego vehicle, or other views. The image capture system may be coupled to a processing system that is able to analyze images and detect license plate numbers.

The ego vehicle 302 scans a target vehicle 304 and obtains an image of the license plate of the target vehicle 304. A license plate number 306 is obtained from the image of the license plate. It is understood that the license plate number may be any alphanumeric string used to uniquely identify a license plate. License plate numbers may vary in length. Some plates use two characters while others have as many as eight characters. Plates for different countries and jurisdictions have different formats.

A plate is identified by a combination of its issuing jurisdiction and its number. As such, a license plate number of “ABC001” issued from Minnesota is distinct from a plate number of “ABC001” issued from Maine. The license plate analysis is able to determine both the issuing jurisdiction and the plate number.

The ego vehicle 302 transmits the plate number and issuing jurisdiction to a central system 308. The central system 308 may access, cooperate, or partner with one or more other service providers 310A-N, which share information about vehicles.

When a vehicle plate number and issuing jurisdiction is provided to the central system 308, the make, model, and model year of the target vehicle 304 can be obtained. For instance, the central system 308 may interface with one or more government, insurance, public, or private databases to obtain registration information about the target vehicle 304 based on the plate number and issuing jurisdiction. The make, model, and model year of the target vehicle 304 may be transmitted to one or more editorial data services 312A-N. Editorial data services 312A-N include online services such as Edmunds.com, Inc., Cars.com, Kelley Blue Book, Autoblog, and the like. Editorial data services 312A-N may provide resources to research vehicles, including vehicle reviews, vehicle test metrics, reliability reports, recall information, and the like. Editorial data services 312A-N may keep an exhaustive record of vehicle reviews and reputation scores. Using this type of information, the central system 308 is able to calculate a vehicle reputation—the first component of the VFS.

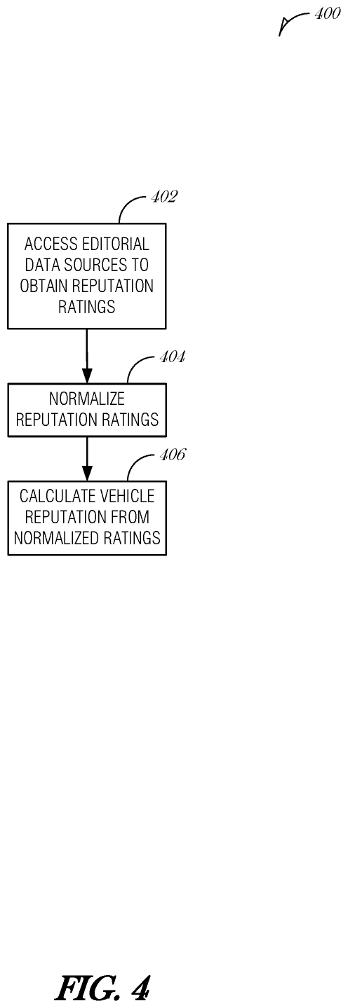

FIG. 4 is a flowchart illustrating a method 400 for calculating a vehicle reputation, according to an example. At 402, one or more editorial data sources are accessed to obtain reputation ratings for a vehicle, given one or more of the vehicle's make, model, or model year. Each editorial data source may use its own rating system (e.g., 5-star rating, 10 point rating scale, 100 point rating scale, etc.). Because of this, at 404, the reputation ratings of each editorial data source is normalized to a common numerical scale. In an example, reputation ratings from editorial data sources are normalized to a range of [0,100] (i.e., zero to one hundred). At 406, a vehicle reputation is calculated as an average of the normalized ratings. This value is part of the aggregation used to calculate the VFS.

Returning to FIG. 3, the central system 308 may also transmit the make, model, and model year of the target vehicle 304 to various other service providers 310A-N that store maintenance records, accident reports, recalls, service records, or other information used in a maintenance risk calculation. Using this type of information, the central system 308 is able to calculate a maintenance risk—the second component of the VFS.

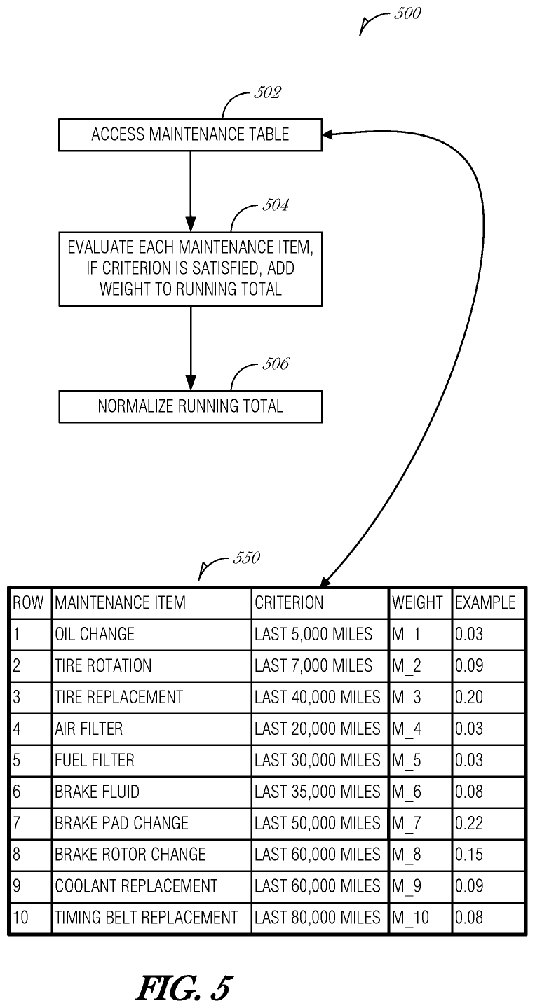

FIG. 5 is a flowchart illustrating a method 500 for calculating a maintenance risk, according to an example. An example maintenance table 550 is illustrated in FIG. 5. The maintenance table 550 includes a list of maintenance items that are considered important for the reliable operation of a vehicle. The contents of the maintenance table 550 may be modified as part of a system design. The maintenance table 550 includes a maintenance item description, a criterion, and a criticality weight. The weight values used in the table 550 are examples and any values may be used according to system design.

The criticality weight column includes weights that emphasize the importance of each maintenance item in terms of road safety. For example, the weight of changing an air filter in the last 20,000 miles (M_4) may be less than that of brake pad change in the last 60,000 miles (M_7) as brakes are more important from a road safety perspective. The value of each weight may be in the range [0,1] and may vary depending on the system design, but the sum of all of the weights must total one.

At 502, the maintenance table (e.g., table 550) is accessed to obtain the list of maintenance items and corresponding criteria and weights. For instance, maintenance table 550 is accessed and ten maintenance items are read.

At 504, each maintenance item is evaluated and if the corresponding criterion is satisfied, then the weight for that maintenance item is added to a running total. A vehicle maintenance record may be accessed and used to evaluate whether the criterion is satisfied. Assumptions may be made based on an average miles driven per year, a date of last service, a current date, a type or use of the vehicle, and other data. If the system cannot determine whether the maintenance item was completed, then a default weight of zero can be used, which indicates a worst case scenario. Example weights are illustrated in the maintenance table 550. It is understood that the weights may be modified based on various design considerations.

At 506, after the maintenance items are evaluated, the running total is normalized to a range of [0,100] (i.e., zero to one hundred), so that it is in the same scale as the vehicle reputation. This is performed by multiplying the running total by 100. The result represents the maintenance risk of a vehicle. This value is part of the aggregation used to calculate the VFS.

Returning to FIG. 3, the central system 308 may also transmit the make, model, and model year of the target vehicle 304 to a service provider 310A-N that provides vehicle reliability and safety data to obtain data for a survival likelihood calculation. For instance, the vehicle reliability and safety data service 310A-N may maintain statistical information on the fatality risk for different makes, models, or model years of a vehicle. An example vehicle reliability and safety data service 310A-N is the National Highway Traffic Safety Administration (NHTSA). The NHTSA partners with state and local governments to help enforce vehicle performance standards. It also assesses and tracks safety ratings, recalls, and other information for vehicle models. The NHTSA also provides various reports, including one of how vehicle age and model year correlate to vehicle safety. Using this type of information, the central system 308 is able to calculate a survival likelihood—the third component of the VFS.

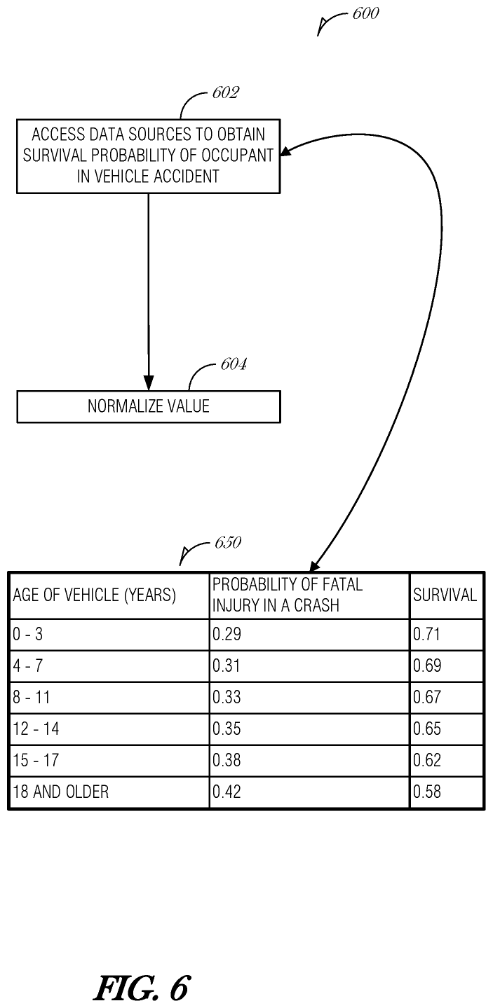

FIG. 6 is a flowchart illustrating a method 600 for calculating a survival likelihood, according to an example. At 602, one or more data sources are accessed to obtain a survival probability of an occupant in a given vehicle. The probability may be based on different factors including the age, make, model, or model year, of the vehicle. In an example, a vehicle age versus fatality probabilities database is used. Based on the probability of fatality, one can derive the probability of survival. An example database is illustrated in FIG. 6 as table 650 with the age of a vehicle and corresponding probabilities of fatality and survival.

At 604, after the survival probability is obtained, the value is normalized to a range of [0,100] (i.e., zero to one hundred), so that it is in the same scale as the vehicle reputation and maintenance risk. This is performed by multiplying the matching survival probability illustrated in the table 650 by 100. The result represents the survival likelihood when operating a vehicle. In the example illustrated here, there is a single data source; however, in other examples where multiple data sources are used, an average probability of survival may be used. This value is part of the aggregation used to calculate the VFS.

Returning to FIG. 3, once the central system 308 has obtained, accessed, calculated, or otherwise determined the components of the vehicle fitness score (VFS), (vehicle reputation, maintenance risk, and survival likelihood), a risk aggregator process is used to combine the components into the VFS trust metric. In an example, the VFS trust metric is computed using the following:

$$VFS = ( VR * w 1 ) + ( MR * w 2 ) + ( SL * w 3 )$$

where VR is the vehicle reputation, MR is the maintenance risk, SL is the survival likelihood, and w1, w2, and w3 are weights. In an example, the sum of the weights w1, w2, and w3 is one. This provides an output range of [0,100] for the value VFS with a higher VFS indicating a more reliable, safer vehicle.

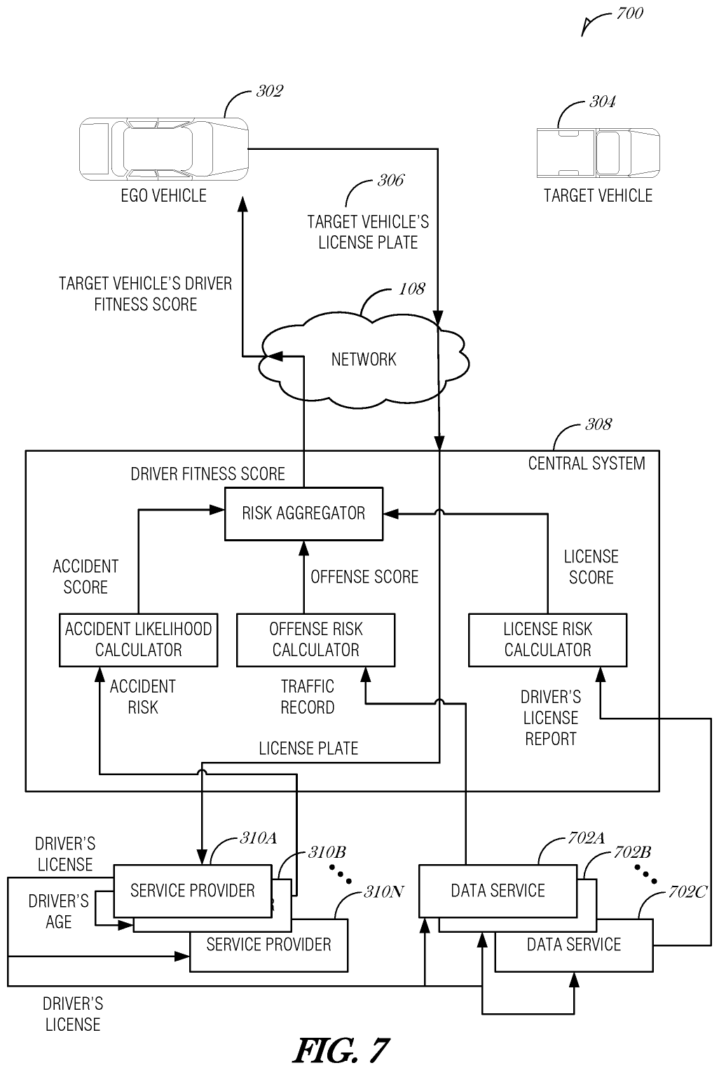

FIG. 7 is a diagram illustrating an operational environment 700, according to an example. The operational environment 700 is used to determine a second example trust metric—the driver fitness score (DFS). At a high level, the DFS is calculated using three components: 1) license risk; 2) accident likelihood; and 3) offense risk. More or fewer components may be used to calculate the DFS. The components are combined, e.g., in a weighted formula, to derive the DFS for a particular vehicle.

As discussed above, an ego vehicle 302 scans a target vehicle 304 and obtains an image of the license plate of the target vehicle 304. The ego vehicle 302 transmits the plate number and issuing jurisdiction to a central system 308. The central system 308 may access, cooperate, or partner with one or more other service providers 310A-N, which share information about vehicles. The make, model, and model year of the target vehicle 304 may be determined and transmitted to one or more data services 702A-N. Data services 702A-N include public or private databases that store information about traffic violations for licensed drivers. Data services may include police department systems, correctional facilities systems, court docketing systems, governmental agency systems, and the like. Using this type of information, the central system 308 is able to calculate a license risk—the first component of the DFS.

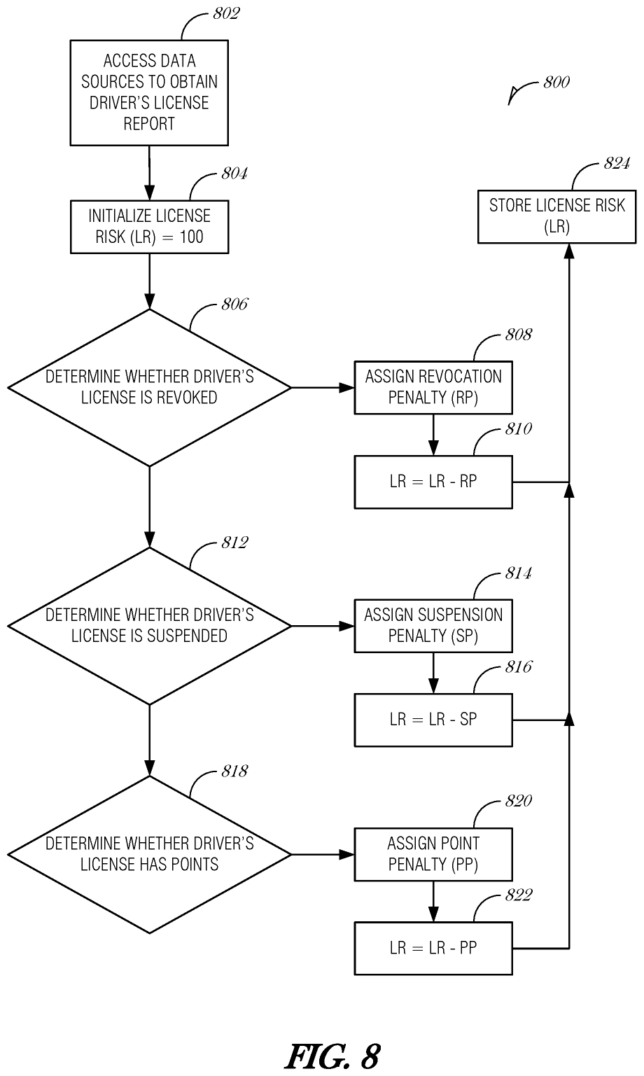

FIG. 8 is a flowchart illustrating a method 800 for calculating a license risk, according to an example. At 802, one or more data sources are accessed to obtain status information for a license of a person registered as the owner of a vehicle matching the license plate number and issuing jurisdiction. The data sources include a department of motor vehicles, a department of public safety, a police department, an insurance company system, or the like. The status information includes whether the license is revoked, whether the license is suspended, and if applicable to the jurisdiction, whether the license has any points on it. In some jurisdictions, points are recorded against a license when the person holding the license received a traffic ticket. Accumulating too many points may result in suspension or revocation of a person's license.

At 804, the license risk (LR) is initialized to the value 100. At 806, it is determined whether the license is revoked. If the license is revoked, then at operation 808, a penalty is assigned to variable revocation penalty (RP). In an example, the RP value is set to 100. This represents the riskiest type of driver. The license risk is then set as:

$$LR = LR - RP$$

and saved, at operation 810. It is understood that any value may be used for the revocation penalty (RP) depending on design.

At 812, it is determined whether the license is suspended. If the license is suspended, then at operation 814, a penalty is assigned to variable suspension penalty (SP). In an example, the SP value is set to 75. Suspension is not as severe as revocation, but it is still a significant risk, so the penalty is also significant. The license risk is then set as:

$$LR = LR - SP$$

and saved, at operation 816. It is understood that any value may be used for the suspension penalty (SP) depending on the intended design.

At 818, it is determined whether the license has any points on it. If there are points on the license, then at operation 820, a penalty is assigned to variable point penalty (PP). The penalty uses the number of points as a function of the penalty. In an example, the number of points on a license is divided by a maximum number of points, and then the result is multiplied by 100 to calculate the PP. The maximum number of points may be set by the license issuing authority and may reflect the total number of possible points before the license is suspended, revoked, or some other threshold value or event. The license risk is then set as:

$$LR = LR - PP$$

and saved, at operation 822. It is understood that any value may be used for the point penalty (PP) depending on the intended design. At operation 824, the license risk (LR) is stored. This value is part of the aggregation used to calculate the DFS.

Returning to FIG. 7, the central system 308 may also transmit the make, model, and model year of the target vehicle 304 to obtain license information of a registered vehicle driver of the target vehicle 304. The driver's age or date of birth is included in the license information. Using one of these dates and the current date, an age and a gender of the licensed driver is determined. Using this type of information, the central system 308 is able to calculate an accident risk—the second component of the DFS.

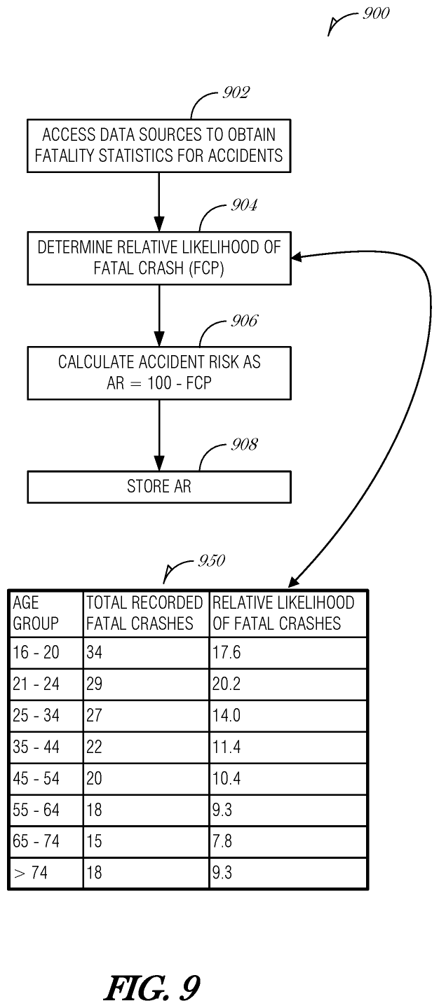

FIG. 9 is a flowchart illustrating a method 900 for calculating an accident risk, according to an example. At 902, one or more data sources are accessed to obtain fatality statistics for accidents. In an example, a table 950 with accident data from the NHTSA is used. The accident data is a view of fatalities as a function of driver age.

At 904, the driver's age is used to determine the relative likelihood of fatal crash (FCP), for example, by referencing the table 950. At 906, the accident risk is calculated as:

$$AR = 100 - FCP$$

where FCP is relative likelihood of a fatal crash. At operation 908, the accident risk (AR) is stored. This value is part of the aggregation used to calculate the DFS.

Returning to FIG. 7, the central system 308 may also transmit the make, model, and model year of the target vehicle 304 to obtain traffic violations (e.g., a driving record) of a registered vehicle driver of the target vehicle 304. Using this type of information, the central system 308 is able to calculate an offense risk—the third component of the DFS.

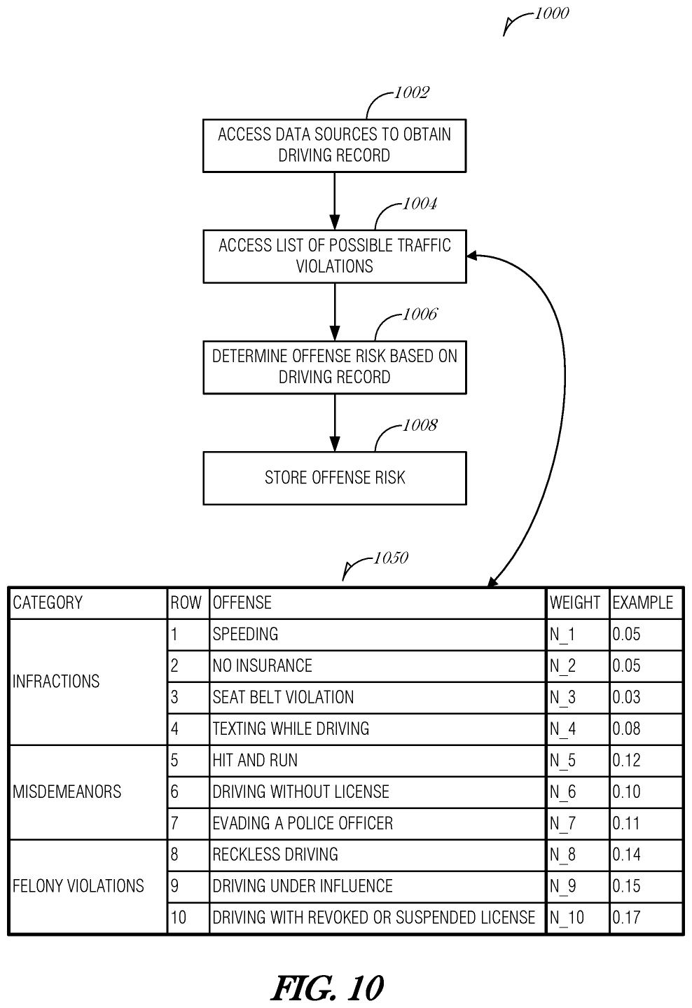

FIG. 10 is a flowchart illustrating a method 1000 for calculating an offense risk, according to an example. The offense risk is a metric of how risky a driver is based on their history of traffic offenses. The more offenses on their driving record, the riskier the driver is to be around. Because of how the offense risk score is used in the aggregation for the DFS, a higher offense risk reflects a safer driver.

At 1002, one or more data sources are accessed to obtain a driving record of the licensed driver. A driver with multiple violations has a higher risk than one with fewer or no violations.

At 1004, a list of possible traffic violations is accessed. The list of possible traffic violations may be specific to the jurisdiction where the driver is licensed. An example list of possible traffic violations is illustrated in FIG. 10 as table 1050. The table 1050 includes traffic infractions (the least serious type of traffic violation), traffic misdemeanors, and felony traffic violations (the most serious type of traffic violation). Weights are used to indicate the perceived riskiness of a driver with the corresponding type of offense on their record. Each weight is in the range [0,1] with the sum of all weights being 1.

At 1004, the driver's traffic violation record is used to determine the offense risk. Each possible traffic violation is checked and if the driver has committed that traffic offense, then the weight is used to compute offense risk. For example, by referencing the table 1050, at 1006, the offense risk is calculated by first summing weights of offenses that the driver has committed. This sum is then subtracted from the value 1 and multiplied by 100. As such, someone who has committed all of the traffic violations in the table 1050 would have an offense risk of 0=(1−1)*100. Someone who has committed a minor violation with a weight of 0.05 would have an offense risk of 95=(1−0.05)*100. Someone who has not committed any traffic violations would have a score of 100=(1−0)*100. The weight values used in the table 1050 are examples and any values may be used according to system design. At operation 1008, the offense risk (OR) is stored. This value is part of the aggregation used to calculate the DFS.

Returning to FIG. 7, once the central system 308 has obtained, accessed, calculated, or otherwise determined the components of the driver fitness score (DFS), (license risk; accident likelihood; and offense risk), a risk aggregator process is used to combine the components into the DFS trust metric. In an example, the DFS trust metric is computed using the following:

$$DFS = ( LR * w 1 ) + ( AL * w 2 ) + ( OR * w 3 )$$

where LR is the license risk, AL is the accident likelihood, OR is the offense risk, and w1, w2, and w3 are weights. In an example, the sum of the weights w1, w2, and w3 is one. This provides an output range of [0,100] for the value DFS with a higher DFS indicating a more reliable, safer driver.

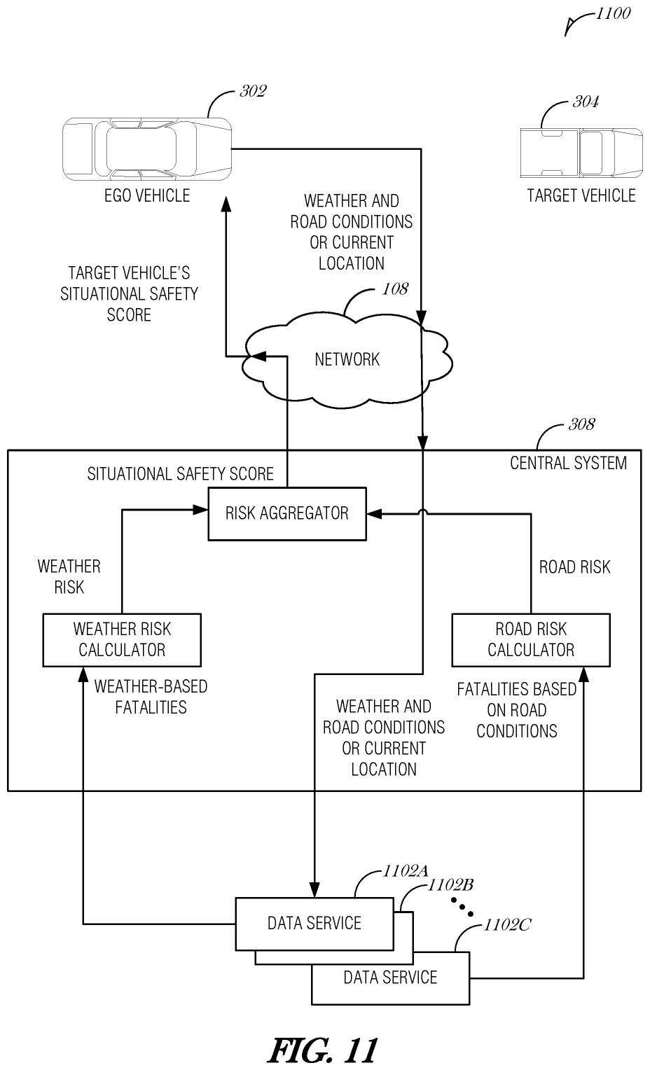

FIG. 11 is a diagram illustrating an operational environment 1100, according to an example. The operational environment 1100 is used to determine a third example trust metric—the situational safety score (SSS). At a high level, the SSS is calculated using two components: 1) weather risk; and 2) road risk. More or fewer components may be used to calculate the SSS. The components are combined, e.g., in a weighted formula, to derive the SSS for a particular vehicle.

As discussed above, an ego vehicle 302 includes various sensors to determine current weather and road conditions in the ego vehicle's operating environment. The ego vehicle 302 may communicate with a central system 308 to obtain a SSS for the ego vehicle 302. In an example, the ego vehicle 302 transmits weather and road conditions to the central system 308. In another example, the ego vehicle 302 transmits a current location (e.g., latitude and longitude) to the central system 308 and the central system 308 is able to determine weather conditions in that area, and then infer road conditions.

One or more data services 1102A-N, which may include public or private databases that store information about traffic accident, fatalities, and their correspondence with weather or road conditions, are accessed. Data services may include insurance systems, governmental agency systems, and the like. Using this type of information, the central system 308 is able to calculate a weather risk—the first component of the SSS.

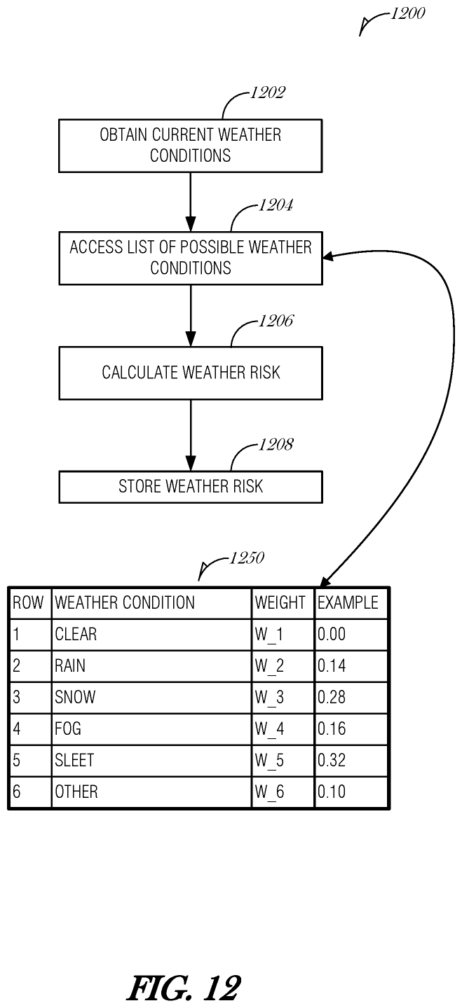

FIG. 12 is a flowchart illustrating a method 1200 for calculating a weather risk, according to an example. The weather risk is a metric of how risky it is to operate a vehicle in various weather conditions. The more weather conditions that apply to the current operating environment, the riskier the driving conditions. Because of how the weather risk score is used in the aggregation for the SSS, a higher weather risk reflects safer driving conditions.

At 1202, one or more data sensors are used to obtain the current weather conditions. At 1204, a list of possible weather conditions is accessed. The list of possible weather conditions may be based on an underlying report or study. An example list of possible weather conditions is illustrated in FIG. 12 as table 1250. The table 1250 includes weather conditions that were used in a report drafted by the American Automobile Association (AAA) ((“Motor Vehicle Crashes, Injuries, and Deaths in Relation to Weather Conditions, United States, 2010-2014”, AAA Foundation for Traffic Safety, January 2016). The AAA report “investigate [d] the number of motor vehicle crashes, injuries, and deaths that occurred in the United States in years 2010-2014 in relation to the weather conditions and weather-related roadway surface conditions present at the time of the crash.” Weights are used to indicate the perceived risk due to the corresponding type of weather condition. Each weight is in the range [0,1] with the sum of all weights being 1. The weight values used in the table 1250 are examples and any values may be used according to system design.

At 1204, the current weather conditions are used to determine the weather risk. Each possible weather condition is checked and if the condition exists, at least in part, in the current weather conditions, then the weight is used to compute weather risk. For example, by referencing the table 1250, at 1206, the weather risk is calculated by first summing weights of conditions that exist. This sum is then subtracted from the value 1 and multiplied by 100. At operation 1208, the weather risk (WR) is stored. This value is part of the aggregation used to calculate the SSS.

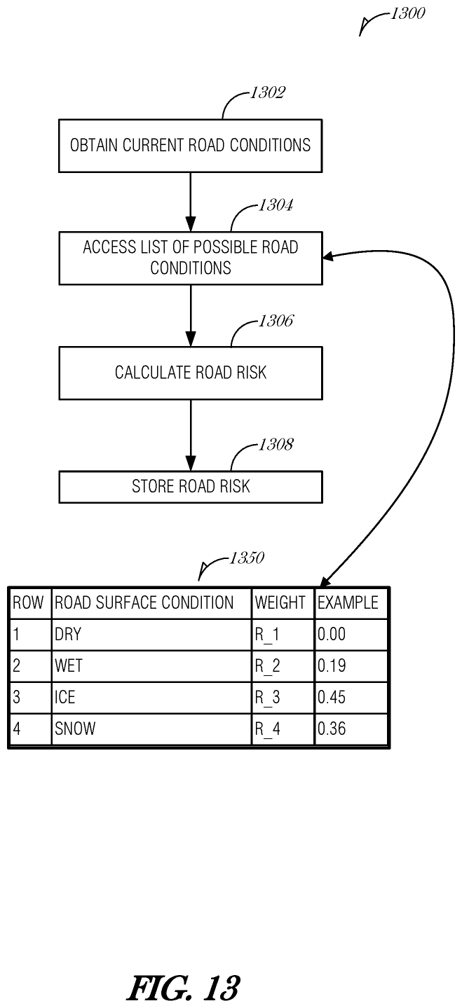

FIG. 13 is a flowchart illustrating a method 1300 for calculating a road risk, according to an example. The road risk is a metric of how risky it is to operate a vehicle in various road conditions. Because of how the road risk score is used in the aggregation for the SSS, a higher road risk reflects safer driving conditions.

At 1302, one or more data sensors are used to obtain the current road conditions. At 1304, a list of possible road conditions is accessed. The list of possible road conditions may be based on an underlying report or study. An example list of possible road conditions is illustrated in FIG. 13 as table 1350. The table 1350 includes road conditions that were used in a report drafted by the American Automobile Association (AAA). The AAA report “investigate [d] the number of motor vehicle crashes, injuries, and deaths that occurred in the United States in years 2010-2014 in relation to the weather conditions and weather-related roadway surface conditions present at the time of the crash.” (“Motor Vehicle Crashes, Injuries, and Deaths in Relation to Weather Conditions, United States, 2010-2014”, AAA Foundation for Traffic Safety, January 2016). Weights are used to indicate the perceived risk due to the corresponding type of road condition. Each weight is in the range [0,1] with the sum of all weights being 1. The weight values used in the table 1350 are examples and any values may be used according to system design.

At 1304, the current road conditions are used to determine the road risk. Each possible road condition is checked and if the condition exists, at least in part, in the current road conditions, then the weight is used to compute road risk. For example, by referencing the table 1350, at 1304, the road risk is calculated by first summing weights of conditions that exist. This sum is then subtracted from the value 1 and multiplied by 100. At operation 1308, the road risk (RR) is stored. This value is part of the aggregation used to calculate the SSS.

Returning to FIG. 11, once the central system 308 has obtained, accessed, calculated, or otherwise determined the components of the situational safety score (SSS), (weather risk and road risk), a risk aggregator process is used to combine the components into the SSS trust metric. In an example, the SSS trust metric is computed using the following:

$$SSS = ( WR * w 1 ) + ( RR * w 2 )$$

where WR is the weather risk, RR is the road risk, and w1, w2, and w3 are weights. In an example, the sum of the weights w1, w2, and w3 is one. This provides an output range of [0,100] for the value SSS with a higher SSS indicating a safer operating environment.

As a result of the operations described in FIGS. 2-13, a requesting AV will have three scores at its disposal to establish a level of trust based on independent and unbiased information about a target vehicle (e.g., another vehicle operating in vicinity around the requested AV). The extrinsic information provided to the AV can help it make decisions to improve road safety by minimizing the risk to itself and others on the road. Scores may be used by insurance, law enforcement, licensing agencies, or other entities to regulate drivers or vehicles.

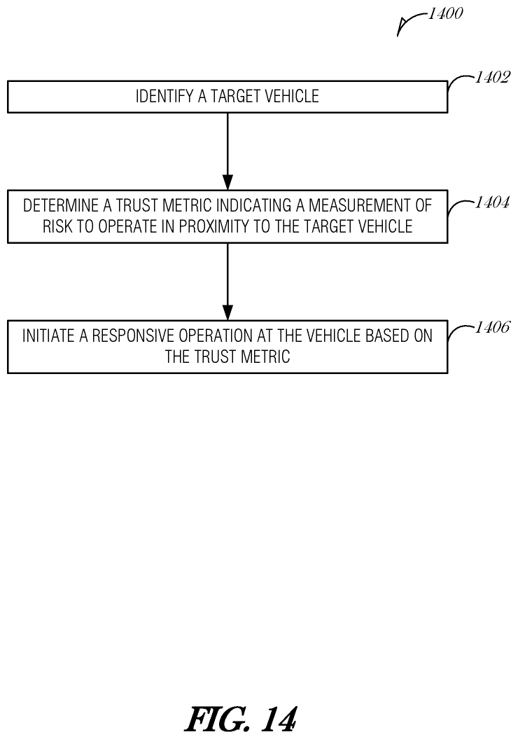

FIG. 14 is a flowchart illustrating a method 1400 for generating a trust metric, according to an embodiment. The method 1400 may be performed by a system (e.g., vehicle control system) of a vehicle having access to a network. At 1402, the method 1400 includes identifying, using a sensors coupled to the vehicle, a target vehicle operating in proximity of the vehicle;

At 1404, the method 1400 includes determining a trust metric, the trust metric indicating a measurement of risk to operate the vehicle in the proximity of the target vehicle. In an embodiment, identifying the target vehicle includes identifying the target vehicle based on a license plate number of the target vehicle. In a further embodiment, the license plate is obtained using the sensors coupled to the vehicle.

In an embodiment, the trust metric includes a situational safety score and determining the situational safety score is performed by determining a current weather condition of an environment the vehicle is operating in, obtaining a current road condition over which the vehicle is travelling, and transmitting the current weather condition and the current road condition to a central system via the network, the central system to calculate a situational safety score based on at least: a weather risk and a road risk, where the weather risk is based on statistics of weather-based fatalities, and the road risk is based on statistics of fatalities correlated with road conditions.

In an embodiment, the trust metric includes a vehicle fitness score, and determining the vehicle fitness score is performed by transmitting the license plate number to a central system via the network, the central system to calculate a vehicle fitness score based on at least: a reputation of the target vehicle, a maintenance risk of the target vehicle, and a probability of survival of a person involved in a collision with the target vehicle.

In an embodiment, the trust metric includes a driver fitness score, and determining the driver fitness score is performed by transmitting the license plate number to a central system via the network, the central system to calculate a driver fitness score based on at least: a license score, an offense score, and an accident score, wherein the license score is based on a driver license report of a driver of the target vehicle, the offense score is based on a traffic record of the driver of the target vehicle, and the accident risk is based on an age of the driver of the target vehicle.

At 1406, the method 1400 includes initiating a responsive operation at the vehicle, using the vehicle controller, based on the trust metric. In various embodiments, the responsive operation includes initiating navigational controls to guide the vehicle to avoid the target vehicle, initiating an alert to a passenger of the vehicle regarding the target vehicle, initiating an alert to a passenger of the vehicle regarding a driver of the target vehicle or initiating a braking mechanism to slow the vehicle down and increase a following distance behind the target vehicle.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instructions on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

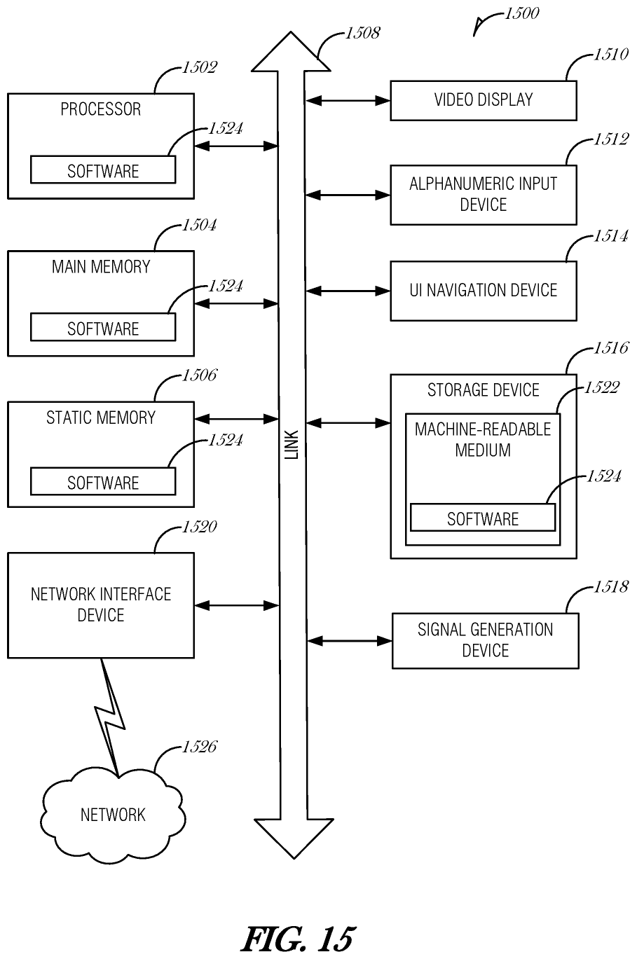

FIG. 15 is a block diagram illustrating a machine in the example form of a computer system 1500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 1500 includes at least one processor 1502 (e.g., a central processing unit (CPU), a graphics processing unit (GPU) or both, processor cores, compute nodes, etc.), at least one co-processor 1503 (e.g., FPGA, specialized GPU, ASIC, etc.), a main memory 1504 and a static memory 1506, which communicate with each other via a link 1508 (e.g., bus). The computer system 1500 may further include a video display unit 1510, an alphanumeric input device 1512 (e.g., a keyboard), and a user interface (UI) navigation device 1514 (e.g., a mouse). In one embodiment, the video display unit 1510, input device 1512 and UI navigation device 1514 are incorporated into a touch screen display. The computer system 1500 may additionally include a storage device 1516 (e.g., a drive unit), a signal generation device 1518 (e.g., a speaker), a network interface device 1520, and one or more sensors (not shown), such as a global positioning system (GPS) sensor, compass, accelerometer, gyrometer, magnetometer, or other sensor.

The storage device 1516 includes a machine-readable medium 1522 on which is stored one or more sets of data structures and instructions 1524 (e.g., software) embodying or utilized by any one or more of the methodologies or functions described herein. The instructions 1524 may also reside, completely or at least partially, within the main memory 1504, static memory 1506, and/or within the processor 1502 during execution thereof by the computer system 1500, with the main memory 1504, static memory 1506, and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions 1524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1524 may further be transmitted or received over a communications network 1526 using a transmission medium via the network interface device 1520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Network interface device 1520 may be configured or programmed to implement the methodologies described herein. In particular, the network interface device 1520 may provide various aspects of packet inspection, aggregation, queuing, and processing. The network interface device 1520 may also be configured or programmed to communicate with a memory management unit (MMU), processor 1502, main memory 1504, static memory 1506, or other components of the system 1500 over the link 1508. The network interface device 1520 may query or otherwise interface with various components of the system 1500 to inspect cache memory; trigger or cease operations of a virtual machine, process, or other processing element; or otherwise interact with various computing units or processing elements that are in the system 1500 or external from the system 1500.

### Additional Notes & Examples

Example 1 is a system of a vehicle having access to a network, comprising: a communication controller to interface with at least one of: a mobile device, the vehicle, and sensors coupled to the vehicle; and a vehicle controller to perform a responsive operation at the vehicle; wherein the system is to: identify a target vehicle operating in proximity of the vehicle; determine a trust metric, the trust metric indicating a measurement of risk to operate the vehicle in the proximity of the target vehicle; and initiate the responsive operation at the vehicle, using the vehicle controller, based on the trust metric.

In Example 2, the subject matter of Example 1 includes, wherein the trust metric comprises a situational safety score, and wherein to determine the situational safety score, the system is to: determine a current weather condition of an environment the vehicle is operating in; obtain a current road condition over which the vehicle is travelling; and transmit the current weather condition and the current road condition to a central system via the network, the central system to calculate a situational safety score based on at least: a weather risk and a road risk, wherein the weather risk is based on statistics of weather-based fatalities, and the road risk is based on statistics of fatalities correlated with road conditions.

In Example 3, the subject matter of Examples 1-2 includes, wherein to identify the target vehicle, the system is to identify the target vehicle based on a license plate number of the target vehicle.

In Example 4, the subject matter of Example 3 includes, wherein the license plate is obtained using the sensors coupled to the vehicle.

In Example 5, the subject matter of Examples 3-4 includes, wherein the trust metric comprises a vehicle fitness score, and wherein to determine the vehicle fitness score, the system is to transmit the license plate number to a central system via the network, the central system to calculate a vehicle fitness score based on at least: a reputation of the target vehicle, a maintenance risk of the target vehicle, and a probability of survival of a person involved in a collision with the target vehicle.

In Example 6, the subject matter of Examples 3-5 includes, wherein the trust metric comprises a driver fitness score, and wherein to determine the driver fitness score, the system is to transmit the license plate number to a central system via the network, the central system to calculate a driver fitness score based on at least: a license score, an offense score, and an accident score, wherein the license score is based on a driver license report of a driver of the target vehicle, the offense score is based on a traffic record of the driver of the target vehicle, and the accident risk is based on an age of the driver of the target vehicle.

In Example 7, the subject matter of Examples 1-6 includes, wherein the responsive operation comprises: initiating navigational controls to guide the vehicle to avoid the target vehicle.

In Example 8, the subject matter of Examples 1-7 includes, wherein the responsive operation comprises: initiating an alert to a passenger of the vehicle regarding the target vehicle.

In Example 9, the subject matter of Examples 1-8 includes, wherein the responsive operation comprises: initiating an alert to a passenger of the vehicle regarding a driver of the target vehicle.

In Example 10, the subject matter of Examples 1-9 includes, wherein the responsive operation comprises: initiating a braking mechanism to slow the vehicle down and increase a following distance behind the target vehicle.

Example 11 is a method performed by a system of a vehicle having access to a network, comprising: identifying, using a sensors coupled to the vehicle, a target vehicle operating in proximity of the vehicle; determining a trust metric, the trust metric indicating a measurement of risk to operate the vehicle in the proximity of the target vehicle; and initiating a responsive operation at the vehicle, using the vehicle controller, based on the trust metric.

In Example 12, the subject matter of Example 11 includes, wherein the trust metric comprises a situational safety score, and wherein determining the situational safety score comprises: determining a current weather condition of an environment the vehicle is operating in; obtaining a current road condition over which the vehicle is travelling; and transmitting the current weather condition and the current road condition to a central system via the network, the central system to calculate a situational safety score based on at least: a weather risk and a road risk, wherein the weather risk is based on statistics of weather-based fatalities, and the road risk is based on statistics of fatalities correlated with road conditions.

In Example 13, the subject matter of Examples 11-12 includes, wherein identifying the target vehicle comprises identifying the target vehicle based on a license plate number of the target vehicle.

In Example 14, the subject matter of Example 13 includes, wherein the license plate is obtained using the sensors coupled to the vehicle.

In Example 15, the subject matter of Examples 13-14 includes, wherein the trust metric comprises a vehicle fitness score, and wherein determining the vehicle fitness score comprises transmitting the license plate number to a central system via the network, the central system to calculate a vehicle fitness score based on at least: a reputation of the target vehicle, a maintenance risk of the target vehicle, and a probability of survival of a person involved in a collision with the target vehicle.

In Example 16, the subject matter of Examples 13-15 includes, wherein the trust metric comprises a driver fitness score, and wherein determining the driver fitness score comprises transmitting the license plate number to a central system via the network, the central system to calculate a driver fitness score based on at least: a license score, an offense score, and an accident score, wherein the license score is based on a driver license report of a driver of the target vehicle, the offense score is based on a traffic record of the driver of the target vehicle, and the accident risk is based on an age of the driver of the target vehicle.

In Example 17, the subject matter of Examples 11-16 includes, wherein the responsive operation comprises: initiating navigational controls to guide the vehicle to avoid the target vehicle.

In Example 18, the subject matter of Examples 11-17 includes, wherein the responsive operation comprises: initiating an alert to a passenger of the vehicle regarding the target vehicle.

In Example 19, the subject matter of Examples 11-18 includes, wherein the responsive operation comprises: initiating an alert to a passenger of the vehicle regarding a driver of the target vehicle.

In Example 20, the subject matter of Examples 11-19 includes, wherein the responsive operation comprises: initiating a braking mechanism to slow the vehicle down and increase a following distance behind the target vehicle.

Example 21 is at least one non-transitory machine-readable medium including instructions, which when executed by a system of a vehicle having access to a network, cause the system to perform operations comprising: identifying, using a sensors coupled to the vehicle, a target vehicle operating in proximity of the vehicle; determining a trust metric, the trust metric indicating a measurement of risk to operate the vehicle in the proximity of the target vehicle; and initiating a responsive operation at the vehicle, using the vehicle controller, based on the trust metric.

In Example 22, the subject matter of Example 21 includes, wherein the trust metric comprises a situational safety score, and wherein determining the situational safety score comprises: determining a current weather condition of an environment the vehicle is operating in; obtaining a current road condition over which the vehicle is travelling; and transmitting the current weather condition and the current road condition to a central system via the network, the central system to calculate a situational safety score based on at least: a weather risk and a road risk, wherein the weather risk is based on statistics of weather-based fatalities, and the road risk is based on statistics of fatalities correlated with road conditions.

In Example 23, the subject matter of Examples 21-22 includes, wherein identifying the target vehicle comprises identifying the target vehicle based on a license plate number of the target vehicle.

In Example 24, the subject matter of Example 23 includes, wherein the license plate is obtained using the sensors coupled to the vehicle.

In Example 25, the subject matter of Examples 23-24 includes, wherein the trust metric comprises a vehicle fitness score, and wherein determining the vehicle fitness score comprises transmitting the license plate number to a central system via the network, the central system to calculate a vehicle fitness score based on at least: a reputation of the target vehicle, a maintenance risk of the target vehicle, and a probability of survival of a person involved in a collision with the target vehicle.

In Example 26, the subject matter of Examples 23-25 includes, wherein the trust metric comprises a driver fitness score, and wherein determining the driver fitness score comprises transmitting the license plate number to a central system via the network, the central system to calculate a driver fitness score based on at least: a license score, an offense score, and an accident score, wherein the license score is based on a driver license report of a driver of the target vehicle, the offense score is based on a traffic record of the driver of the target vehicle, and the accident risk is based on an age of the driver of the target vehicle.

In Example 27, the subject matter of Examples 21-26 includes, wherein the responsive operation comprises: initiating navigational controls to guide the vehicle to avoid the target vehicle.

In Example 28, the subject matter of Examples 21-27 includes, wherein the responsive operation comprises: initiating an alert to a passenger of the vehicle regarding the target vehicle.

In Example 29, the subject matter of Examples 21-28 includes, wherein the responsive operation comprises: initiating an alert to a passenger of the vehicle regarding a driver of the target vehicle.

In Example 30, the subject matter of Examples 21-29 includes, wherein the responsive operation comprises: initiating a braking mechanism to slow the vehicle down and increase a following distance behind the target vehicle.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system of a vehicle having access to a network, comprising:
a communication controller to interface with at least one of: a mobile device, the vehicle, and sensors coupled to the vehicle; and
a vehicle controller to perform a responsive operation at the vehicle;
wherein the system is to:
identify a target vehicle operating in proximity of the vehicle;
determine a trust metric, the trust metric indicating a measurement of risk to operate the vehicle in the proximity of the target vehicle; and
initiate the responsive operation at the vehicle, using the vehicle controller, based on the trust metric.

2. The system of claim 1, wherein the trust metric comprises a situational safety score, and wherein to determine the situational safety score, the system is to:
determine a current weather condition of an environment the vehicle is operating in;
obtain a current road condition over which the vehicle is travelling; and
transmit the current weather condition and the current road condition to a central system via the network, the central system to calculate a situational safety score based on at least: a weather risk and a road risk, wherein the weather risk is based on statistics of weather-based fatalities, and the road risk is based on statistics of fatalities correlated with road conditions.

3. The system of claim 1, wherein to identify the target vehicle, the system is to identify the target vehicle based on a license plate number of the target vehicle.

4. The system of claim 3, wherein the license plate is obtained using the sensors coupled to the vehicle.

5. The system of claim 3, wherein the trust metric comprises a vehicle fitness score, and wherein to determine the vehicle fitness score, the system is to transmit the license plate number to a central system via the network, the central system to calculate a vehicle fitness score based on at least: a reputation of the target vehicle, a maintenance risk of the target vehicle, and a probability of survival of a person involved in a collision with the target vehicle.

6. The system of claim 3, wherein the trust metric comprises a driver fitness score, and wherein to determine the driver fitness score, the system is to transmit the license plate number to a central system via the network, the central system to calculate a driver fitness score based on at least: a license score, an offense score, and an accident score, wherein the license score is based on a driver license report of a driver of the target vehicle, the offense score is based on a traffic record of the driver of the target vehicle, and the accident risk is based on an age of the driver of the target vehicle.

7. The system of claim 1, wherein the responsive operation comprises:
initiating navigational controls to guide the vehicle to avoid the target vehicle.

8. The system of claim 1, wherein the responsive operation comprises:
initiating an alert to a passenger of the vehicle regarding the target vehicle.

9. The system of claim 1, wherein the responsive operation comprises:
initiating an alert to a passenger of the vehicle regarding a driver of the target vehicle.

10. The system of claim 1, wherein the responsive operation comprises:
initiating a braking mechanism to slow the vehicle down and increase a following distance behind the target vehicle.

11. At least one non-transitory machine-readable medium including instructions, which when executed by a system of a vehicle having access to a network, cause the system to perform operations comprising:
identifying, using a sensors coupled to the vehicle, a target vehicle operating in proximity of the vehicle;
determining a trust metric, the trust metric indicating a measurement of risk to operate the vehicle in the proximity of the target vehicle; and
initiating a responsive operation at the vehicle, using the vehicle controller, based on the trust metric.

12. The machine-readable medium of claim 11, wherein the trust metric comprises a situational safety score, and wherein determining the situational safety score comprises:
determining a current weather condition of an environment the vehicle is operating in;
obtaining a current road condition over which the vehicle is travelling; and
transmitting the current weather condition and the current road condition to a central system via the network, the central system to calculate a situational safety score based on at least: a weather risk and a road risk, wherein the weather risk is based on statistics of weather-based fatalities, and the road risk is based on statistics of fatalities correlated with road conditions.

13. The machine-readable medium of claim 11, wherein identifying the target vehicle comprises identifying the target vehicle based on a license plate number of the target vehicle.

14. The machine-readable medium of claim 13, wherein the license plate is obtained using the sensors coupled to the vehicle.

15. The machine-readable medium of claim 13, wherein the trust metric comprises a vehicle fitness score, and wherein determining the vehicle fitness score comprises transmitting the license plate number to a central system via the network, the central system to calculate a vehicle fitness score based on at least: a reputation of the target vehicle, a maintenance risk of the target vehicle, and a probability of survival of a person involved in a collision with the target vehicle.

16. The machine-readable medium of claim 13, wherein the trust metric comprises a driver fitness score, and wherein determining the driver fitness score comprises transmitting the license plate number to a central system via the network, the central system to calculate a driver fitness score based on at least: a license score, an offense score, and an accident score, wherein the license score is based on a driver license report of a driver of the target vehicle, the offense score is based on a traffic record of the driver of the target vehicle, and the accident risk is based on an age of the driver of the target vehicle.

17. The machine-readable medium of claim 11, wherein the responsive operation comprises:
initiating navigational controls to guide the vehicle to avoid the target vehicle.

18. The machine-readable medium of claim 11, wherein the responsive operation comprises:
initiating an alert to a passenger of the vehicle regarding the target vehicle.

19. The machine-readable medium of claim 11, wherein the responsive operation comprises:
initiating an alert to a passenger of the vehicle regarding a driver of the target vehicle.

20. The machine-readable medium of claim 11, wherein the responsive operation comprises:
initiating a braking mechanism to slow the vehicle down and increase a following distance behind the target vehicle.
